(19) United States
(12) Patent Application Publication
(10) Pub. No.: US 2005/0217163 A1
(43) Pub. Date: Oct. 6, 2005

(54) System for sectional contraction of a flexible material

(76) Inventors: Sondre Jacobsen, Vettre (NO); Harald Tronstad, Vettre (NO)

Correspondence Address: James E Bradley;Bracewell & Patterson, PO Box 61389, Houston, TX, 77208-1389, US

(21) Appl. No.: 10/513,613

(22) PCT Filed: Apr. 14, 2003
(86) PCT No.: PCT/NO03/00118

§ 371 Date: Nov. 5, 2004

(30) Foreign Application Priority Data
May 6, 2002 (NO) 20022151

(51) Int. Cl. A01K 71/00

(52) U.S. Cl. 43/7

(57) ABSTRACT

System for sectional contraction of at least parts of a flexible material (1), such as a fishing net, a net seine or the like, using cables (5, 6) fastened to the material, the cables (5, 6) being movable in relation to the fastening points of the material (1). At least two cables (5, 6) are fastened in the material (1) in a zigzag pattern side by side, where the length of each pattern corresponds to the length of the part of the material to be contracted transverse to the contraction direction. One end (52, 62) of each cable (5, 6) is fastened such that movement transverse to the contraction direction is avoided.

The present invention relates to a system for sectional contraction of a flexible material, such as a fishing net, seine or the like, according to the introduction of independent claim.

### BACKGROUND OF THE INVENTION

There are several installations using fishing nets, seines or the like to keep fish or other animals inside a fixed area, for example net seines. When a hole occurs in the net, some of the fish or animals can escape from the area and be lost to the owner. In most cases, this will result in a considerable economical loss for the owner, at the same time as the escape is can result in environmental damage, especially in connection with net seines, because the escaped fish can carry diseases and infect wild fish populations. Additionally, cross-breeding between fish farming populations and wild fish populations is considered to be undesirable.

Holes in the fish net can occur because of wear, objects floating in the sea and as a result drifting into the fish net, or other circumstances. The holes can be repaired by removing fish from the net, and then removal of the net from operation for repair. It can also be repaired by a diver going out to the net seine, diving down to find the hole and carry out manual repairs. This can be a hazardous process for the diver, especially in bad weather and high waves. In most instances the repairing of a hole in the fish net involves down time, and fish can in this period escape from the net seine.

### OBJECT OF THE INVENTION

The object of the present invention is to provide a system for sectional contraction of at least an area of a flexible material, such as a fishing net, seine or the like. A further object of the invention is that the system should be simple and fast in use, and be economic.

The Invention

The object is achieved by providing a system according to the characterizing part of claim 1. Further preferable features are presented in the dependent claims.

The invention concerns a system for sectional contraction of at least parts of a flexible material. The system can be used on every material being so flexible that it can be contracted. The system comprises at least two cables fastened to the material side by side in a zigzag pattern. The cables expand transversely to the contraction direction, ie if the material is to be contracted horizontally, the cables extend vertically, and if the material is to be contracted vertically, the cables extend horizontally. Each cable extends over the length of the material which shall be contracted, transverse to the contraction direction, while a number of cables, at least two, together cover the length of the material to be contracted in the contraction direction. Since each cable is fastened in a zigzag pattern to the material, the length of the zigzag patterns correspond to the length of the part of the material which is to be contracted transverse to the contraction direction, while the sum of the width of the zigzag patterns and the distance between them will correspond to the part of the material which is to be contracted in the contraction direction.

The material shall be able to be sectional contracted, as the width and the length of one zigzag pattern correspond to the width in the contraction direction and the length transverse to the contradiction of a section respectively.

The cables are fastened to the material such that they can not be torn off, but they can be moved/transferred in relation to the fastening points. To achieve this the cables can be threaded through openings in the material.

In the following, a direction transverse to the contraction direction will be referred to as the cable direction.

The first end of each cable is fastened such that it can not be moved in the cable direction. The end can be fastened to an outer point which does not move in the cable direction, for example the sea bed anchoring or the sea bed for a fish net seine. The ends can also be fastened to the material to be contracted, but then the material must be fastened in the cable direction, such that it will not be contracted in the cable direction when the length of the cables fastened to the material is reduced. In most embodiments it is preferred that all the fastened cable ends are in the same end of the material. The other end of each cable shall be loose or loosely fastened such that the length of the cable being fastened to the material can easily be reduced by pulling this end.

In some embodiments, two cables being fastened to the materials can also be one and the same cable, as the end of the first cable is guided back towards the first end, the like to the second cable. The end of each cable being fastened such that the cable is not moved transverse to the contraction direction is in this case being a part to the cable constituting two cables. This part can either be fastened to an outer point, such that it can not be moved in the cable direction, or can only go from the last fastening point for the first cable along the material in the contraction direction, to the first fastening point for the second cable. In the last case the material must be fastened in the cable direction.

Further, it is preferred that two cables fastened to the material side by side in the contraction direction are fastened in an opposite zigzag pattern, such that the cables are fastened in alternating zigzag patterns in the contradiction direction. Two and two cables in opposite directions can preferably overlap each other at least partially, and preferably are such that they form a pair of double overlapping zigzag patterns. The distance between two cables forming such a pair, and the adjacent pair, can be varied but should not be too large, because the material between the pairs will not be contracted in the same way as the area of the material where the pairs are fastened. Embodiments are preferred, where two such pairs partially overlap each other.

In cases where two cables with opposite zigzag patterns, fastened side by side in the material overlap each other, the cables can preferably alternate as upper and lower cables at the crossover points. This also applies for two cables forming a pair and in the crossover point between two adjacent pairs, as the pairs are overlapping. If the fastening point for one cable is destroyed, the cable in this case will be hooked in the adjacent cable, and the contraction system will still work. Consequently, the load at the fastening point of the cable still having an intact fastening point will be increased.

When an area of the material is to be contracted, the length of the cables being fastened to the material in this area is reduced, because of a pull in the free ends of the cables, ie those ends hot being fastened or just loosely fastened. Since the other ends of the cables are fastened such that they can not be moved in the cable direction, the cables will not be pulled out from the material, but be moved relative to the fastening points in the material. Gradually, the cables will be tightened and the zigzag pattern will be narrower, and the material in the zigzag pattern, ie between the fastening points for the current cable/cables, will be contracted. When the length of the cable is reduced so much that it lies in an approximately straight line through the material, the zigzag pattern and the current area of the material will be maximally reduced. The area of the material to be contracted can comprise one or more sections.

When the system is used in a net seine, the cables in the area around the hole can be shortened, and consequently the area around the hole and the hole itself will be contracted thereby preventing the fish from escaping from the seine.

To prevent a too large load from occurring on the material during the contraction, reinforcing lines are preferably fastened to the material. The reinforcing lines are not to be moved relative to the seine, and therefore can be fastened in known ways, or be woven into the seine during production. The cables are fastened to the lines instead of the material, but shall in the same way as described above be movable relative to the fastening point. The reinforcing lines can be fastened to the material in the contraction direction, the cable direction or on the incline. As mentioned, they do not contribute to the contraction, but are rather a reinforcement of the material, especially at the fastening points for the cables.

To prevent fouling of the cables, to ease the contraction and reduce the danger of damages to the material, among other reasons, the cables can be put in a casing, the casing being fastened in the material, and the cables are able to move inside the casing.

Several contraction systems can be put outside each other in the same area of the material, such that the material can be contracted in more directions.

### EXAMPLE

In the following description of an example of the present invention the system according to the present invention is installed on a net seine, as shown in the drawings, where;

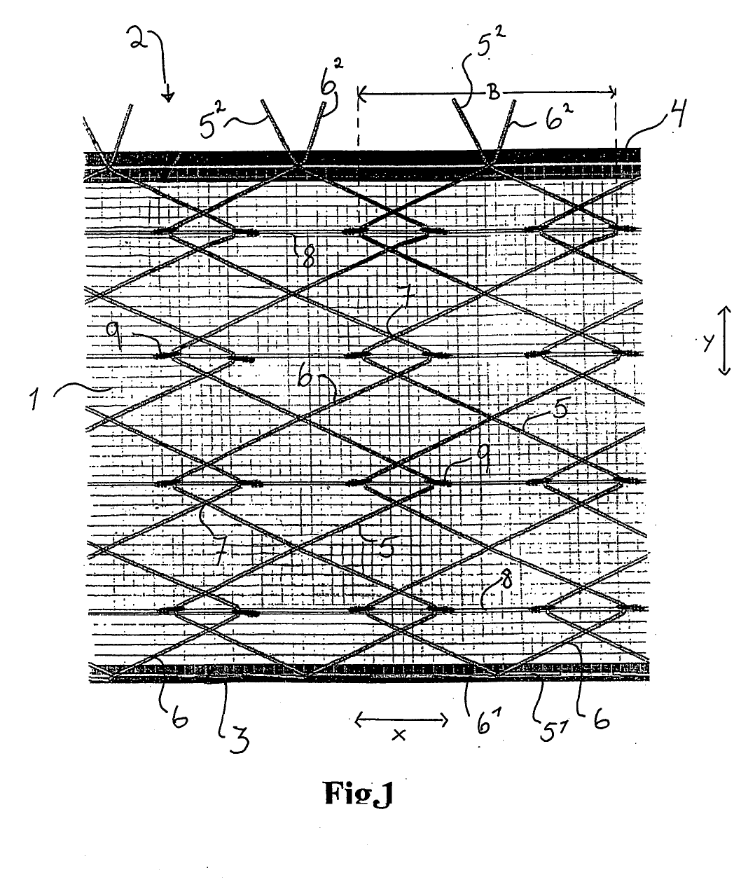

FIG. 1 is a sectional view of a fish net of a net seine with a system for sectional contraction according to the present invention, and

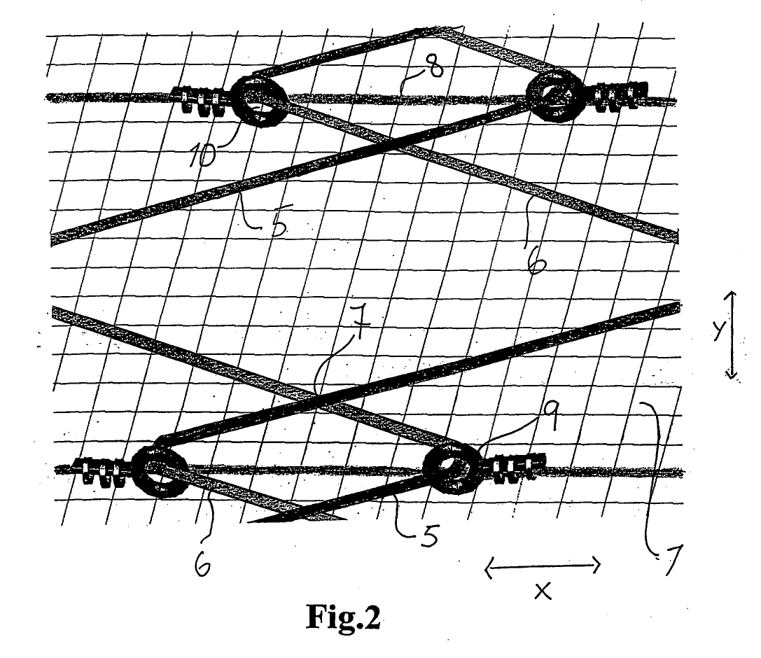

FIG. 2 is a sectional view of a detail of FIG. 1, seen from above.

In FIG. 1 there is shown a prior art fish net 1 in a net seine 2, fastened to a anchoring means 3 in the lower part thereof, and to floating devices 4 in the upper end thereof. The fish net 1 provides a system according to the present invention, as described above. Cables 5, 6 in the system are fastened in vertical direction y to the fish net 1, ie they extend from the bottom of the fish net 1 to the floating devices 4, as the lower end 5¹,6¹ of each cable 5, 6 are fastened to the anchoring means 3, an upper ends 5²,6² of the cables extend up to or above the water surface. Consequently, the fish net is to be contracted in horizontal direction x.

In the illustrated arrangement, the cables 5,6 are fastened in pairs in a double overlapping zigzag pattern, and the cable pairs somewhat overlap each other. The cables 5, 6 in two adjacent cable pairs also overlap each other, and form an intersection point 7 between two cables 5, 6 in opposite zigzag pattern. As shown in FIG. 2, the cables 5,6 alternate as upper and lower cables at these intersection points 7, such that they will be hooked into each other if a fastening point between a cable 5, 6 and the fish net 1 for at least one of the cables becomes damaged.

To avoid wear to the fish net 1, there is shown in the illustrated example horizontally inwrought reinforcing lines 8 The vertical cables 5, 6 are fastened to the lines 8, for example by means of a type of eye screw 9, see FIG. 2, as the screw 9 is fastened to the reinforcing line 8 and the vertical cables 5,6 are threaded through an eye 10 of the screw 9. In this way good fastening to the reinforcing line 8 inwrought with the fish net 1 is achieved, and the cables 5, 6 can easily be moved/transferred in relation to the fastening point.

There are also several ways to fasten the cables to the fish net, but in all cases, the cable must be able to be moved in relation to the fastening point. In its simplest embodiment, the cables are threaded through a rectangle in the net (not shown), and can be guided back to the same side of the net via another rectangle, or can be guided to the next fastening point of the other side of the net.

A further embodiment according to the present invention, not shown in the drawings, comprises a casing around the vertical cables. When such casings are used, the casing can be fastened directly to the net, because it will not be moved in relation to this. During contraction the cables are moved inside the casing, and the casing are contracted in the same way as the net.

If a hole occurs in the net 1, it has to be localized, and the area around the hole has to be contracted. The upper ends of the cables 5², 6², of the cables 5,6 in this area is, for example, fastened to a winch. When the cables 5, 6 are pulled upwardly by the winch, the length of the cables fastened to the net 1 is reduced, and the cables 5, 6 are moved in relation to the fastening points in the net. Consequently, the width (B) of the zigzag pattern is reduced, but as the lower ends of the cables 5², 6² are fastened to the anchoring means and it is not possible to reduce the length/depth of the fish net, because it is anchored to the bottom of the sea and to the floating devices 4. If two and two cables lie in double overlaying zigzag pattern, it is an advantage that both cables 5, 6 forming the pair around the area being contracted, are winched up together. When the width (B) of the zigzag pattern is reduced, the area between the fastening points in the zigzag pattern will be contracted, and the hole will gradually be smaller. When the length of the cables 5, 6 fastened to the net is reduced to the maximum, the zigzag pattern will be very narrow, or reduced to a straight line. The hole in the fish net 1 will be so contracted that fish will not be able to escape. In this way the period of time during which fish can escape from the fish net is drastically reduced. The hole must be repaired later in the normal manner.

The area around the hole in the net can comprise more sections, and more cables and/or cable pairs to be winched to sufficiently contract the area.

It will be understood by persons skilled in the art that the present invention is not just limited to the matter described and shown above. The invention also comprises combinations and subcombinations of the described features, together with modifications and variations of this being obvious to a person skilled in the art, within the scope of the following claims.

1. A system for sectional contraction of at least part of a flexible material, such as a fishing net, a net seine or the like, using cables fastened to the material, the cables being movable in relation to the fastening points of the material, characterized in that
at least two of the cables are fastened in a zigzag pattern side by side in the material to be contracted, where the length of each pattern corresponds to the length of the part of the material to be contracted transverse to the contraction direction, such that by reducing and tightening the cables making up the pattern, the pattern and/or the extension of the material transverse to the contraction direction remain unchanged.

2. The system according to claim 1, wherein said at least two of the cables are fastened in an opposite zigzag pattern.

3. The system according to claim 2, wherein said at least two of the cables are fastened to the material in a partially overlapping manner.

4. The system according to claim 1, wherein said at least two of the cables are fastened to the material in an opposite zigzag pattern that is completely overlapping to form a first pair, and two more of the cables are fastened to the material in an opposite zigzag pattern to form second pair in a double overlapping zigzag pattern with the first pair.

5. The system according to claim 4, wherein there is a distance between two cables forming the first pair, and the two cables forming the second pair.

6. The system according to claim 4, the cables forming the first pair partially overlap the cables forming the second pair.

7. The system according to claim 1, further comprising reinforcing lines fastened to the material in the contraction direction, and wherein said at least two of the cables are fastened to the lines.

8. The system according to claim 1, further comprising reinforcing lines fastened to the material transverse to the contraction direction, and wherein said at least two of the cables are fastened to the lines.
